(19) United States
(12) Patent Application Publication
(10) Pub. No.: US 2026/0288093 A1
(43) Pub. Date: Sep. 24, 2026

(54) IoT Home Appliance Control System

(71) Applicant: SoftBank Group Corp., Tokyo (JP)

(72) Inventor: Ken SONOBE, Tokyo (JP)

(21) Appl. No.: 19/567,295

(22) Filed: Mar. 16, 2026

Related U.S. Application Data
(60) Provisional application No. 63/774,128, filed on Mar. 19, 2025.

(51) Int. Cl. G05B 13/02; G06T 11/00; G06V 20/20; G10L 15/22

(52) U.S. Cl. CPC G05B 13/027; G06T 11/00; G06V 20/20; G10L 15/22; G06T 2200/24; G10L 2015/223

(57) ABSTRACT

An IoT home appliance control system includes a display, a sensor, and a circuit. The display superimposes a virtual interface on a user's field of view. The sensor scans a surrounding environment to recognize an IoT home appliance. The circuit analyzes a voice instruction from the user to generate an operation command corresponding to the voice instruction from the user, and generates a control signal for controlling the IoT home appliance based on the operation command.

### CROSS-REFERENCE TO RELATED APPLICATION

This application claims the benefit of priority from U.S. Provisional Patent Application No. 63/774,128, filed on Mar. 19, 2025. The entire contents of the priority application are incorporated herein by reference.

### BACKGROUND

The technology of the present disclosure relates to a system.

Japanese Unexamined Patent Application Publication No. 2022-180282 discloses a method, which is a persona chatbot control method performed by at least one processor, the method including a step of receiving a user utterance, a step of adding the user utterance to a prompt including an instruction sentence associated with a description regarding a character of a chatbot, a step of encoding the prompt, and a step of inputting the encoded prompt to a language model to generate a chatbot utterance responding to the user utterance.

### SUMMARY

The problem to be solved by this disclosure is a lack of intuitiveness and efficiency in the user interface for operating current IoT home appliances. Conventional IoT home appliances are generally operated via a smartphone or a smart speaker, but these methods are indirect for the user and lack an intuitive operational feel. The user needs to open an application or remember specific voice commands, which leads to operational complexity and a decline in the user experience.

Furthermore, there is also a problem that it is difficult to provide a personalized experience because these interfaces cannot sufficiently respond to the individual needs and habits of the user. The user needs to repeat the same operation each time, which causes a waste of time and stress.

This disclosure aims to provide a new user interface that allows a user to interact directly and naturally with IoT home appliances by combining MR technology and generative AI. This allows the user to visually check the status of the home appliance and operate it intuitively by voice. In addition, by having the generative AI learn the user's past operation history and preferences, it can make more personalized suggestions and support optimal operations based on the user's habits. This makes it possible to improve the user experience and increase operational efficiency, thereby solving the conventional problems.

As a means for solving the problem, the present disclosure provides a system including an MR device unit, a generative AI unit, and an IoT home appliance control unit. The MR device unit has a display means for superimposing a virtual interface on the user's field of view, and further includes a sensor means for scanning the surrounding environment to recognize an IoT home appliance. This allows the user to visually confirm operation options for the home appliance when approaching the IoT home appliance.

The generative AI unit includes a natural language processing means for analyzing a user's voice instruction and understanding its intent. Furthermore, it is possible to learn the user's past operation history and preferences using a machine learning means and predict the user's behavior patterns. This allows the user's voice instruction to be converted into a specific operation command and transmitted to the IoT home appliance control unit.

The IoT home appliance control unit includes a communication means for controlling the IoT home appliance based on an operation command from the generative AI unit. By this communication means, the IoT home appliance can change its operation according to the user's instruction and realize an operation in line with the user's intent.

With these configurations, the user can interact directly and naturally with the IoT home appliance, and it is possible to provide a more intuitive and efficient user experience compared to conventional indirect operation methods.

### BRIEF DESCRIPTION OF DRAWINGS

FIG. 1 is a conceptual diagram illustrating an example of a configuration of a data processing system according to a first embodiment.

FIG. 2 is a conceptual diagram illustrating an example of main functions of a data processing apparatus and a smart device according to the first embodiment.

FIG. 3 is a conceptual diagram illustrating an example of a configuration of a data processing system according to a second embodiment.

FIG. 4 is a conceptual diagram illustrating an example of main functions of a data processing apparatus and smart glasses according to the second embodiment.

FIG. 5 is a conceptual diagram illustrating an example of a configuration of a data processing system according to a third embodiment.

FIG. 6 is a conceptual diagram illustrating an example of main functions of a data processing apparatus and a headset-type terminal according to the third embodiment.

FIG. 7 is a conceptual diagram illustrating an example of a configuration of a data processing system according to a fourth embodiment.

FIG. 8 is a conceptual diagram illustrating an example of main functions of a data processing apparatus and a robot according to the fourth embodiment.

FIG. 9 illustrates an emotion map on which a plurality of emotions are mapped.

FIG. 10 illustrates an emotion map on which a plurality of emotions are mapped.

FIG. 11 is a flowchart illustrating an example of a method for controlling an IoT home appliance.

### DETAILED DESCRIPTION

Hereinafter, an example of an embodiment of a system according to the technology of the present disclosure will be described with reference to the accompanying drawings.

First, terms used in the following description will be described.

In the following embodiments, a processor with a reference sign (hereinafter, simply referred to as a “processor”) may be one arithmetic device or may be a combination of a plurality of arithmetic devices. Also, the processor may be one type of arithmetic device or may be a combination of a plurality of types of arithmetic devices. Examples of the arithmetic device include a CPU (Central Processing Unit), a GPU (Graphics Processing Unit), a GPGPU (General-Purpose computing on Graphics Processing Units), an APU (Accelerated Processing Unit), and the like.

In the following embodiments, a RAM (Random Access Memory) with a reference sign is a memory in which information is temporarily stored, and is used as a work memory by a processor.

In the following embodiments, a storage with a reference sign is one or more non-volatile storage devices that store various programs, various parameters, and the like. Examples of the non-volatile storage device include a flash memory (SSD (Solid State Drive)), a magnetic disk (for example, a hard disk), or a magnetic tape, and the like.

In the following embodiments, a communication I/F (Interface) with a reference sign is an interface including a communication processor, an antenna, and the like. The communication I/F manages communication among a plurality of computers. An example of a communication standard applied to the communication I/F includes a wireless communication standard including 5G (5th Generation Mobile Communication System), Wi-Fi (registered trademark), or Bluetooth (registered trademark), and the like.

In the following embodiments, “A and/or B” is synonymous with “at least one of A and B”. That is, “A and/or B” means that it may be A only, B only, or a combination of A and B. Also, in the present specification, when three or more matters are expressed by being connected with “and/or”, the same concept as “A and/or B” is applied.

### First Embodiment

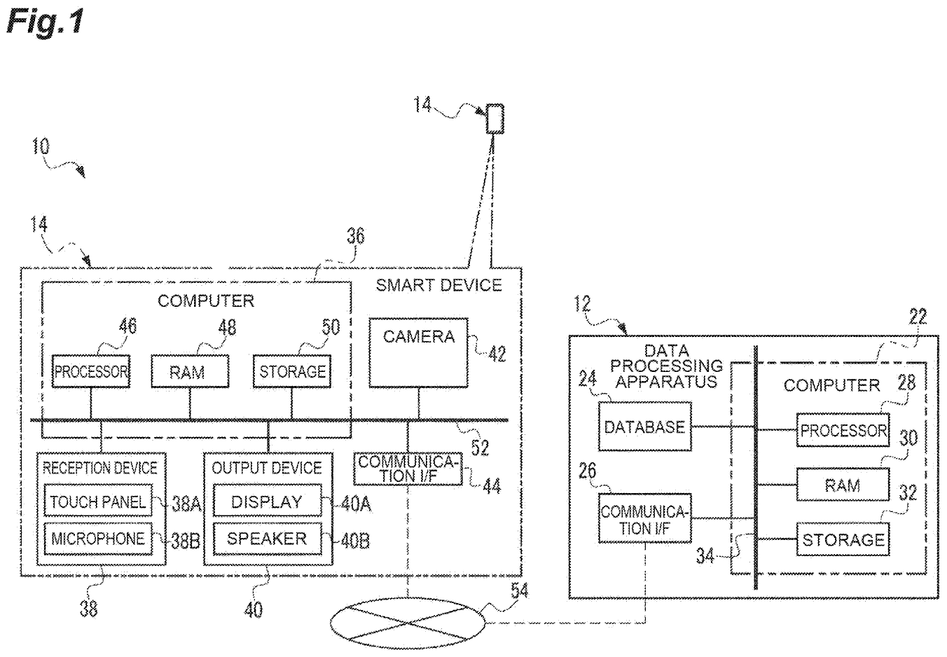

FIG. 1 illustrates an example of a configuration of a data processing system 10 according to a first embodiment.

As illustrated in FIG. 1, the data processing system 10 includes a data processing apparatus 12 and a smart device 14. An example of the data processing apparatus 12 includes a server.

The data processing apparatus 12 includes a computer 22, a database 24, and a communication I/F 26. The computer 22 is an example of a “computer” according to the technology of the present disclosure. The computer 22 includes a processor 28, a RAM 30, and a storage 32. The processor 28, the RAM 30, and the storage 32 are connected to a bus 34. Also, the database 24 and the communication I/F 26 are also connected to the bus 34. The communication I/F 26 is connected to a network 54. An example of the network 54 includes a WAN (Wide Area Network) and/or a LAN (Local Area Network), and the like.

The smart device 14 includes a computer 36, a reception device 38, an output device 40, a camera 42, and a communication I/F 44. The computer 36 includes a processor 46, a RAM 48, and a storage 50. The processor 46, the RAM 48, and the storage 50 are connected to a bus 52. Also, the reception device 38, the output device 40, and the camera 42 are also connected to the bus 52.

The reception device 38 includes a touch panel 38A, a microphone 38B, and the like, and receives a user input. The touch panel 38A receives a user input by contact of an indicator by detecting contact of the indicator (for example, a pen or a finger, etc.). The microphone 38B receives a user input by voice by detecting a user's voice. A control unit 46A transmits data indicating the user input received by the touch panel 38A and the microphone 38B to the data processing apparatus 12. In the data processing apparatus 12, a specific processing unit 290 acquires the data indicating the user input.

The output device 40 includes a display 40A, a speaker 40B, and the like, and presents data to a user 20 by outputting the data in a representation form (for example, voice and/or text) perceivable by the user 20. The display 40A displays visible information such as text and images in accordance with an instruction from the processor 46. The speaker 40B outputs voice in accordance with an instruction from the processor 46. The camera 42 is a small digital camera on which an optical system such as a lens, a diaphragm, and a shutter, and an image sensor such as a CMOS (Complementary Metal-Oxide-Semiconductor) image sensor or a CCD (Charge Coupled Device) image sensor are mounted.

The communication I/F 44 is connected to the network 54. The communication I/Fs 44 and 26 manage exchange of various information between the processor 46 and the processor 28 via the network 54.

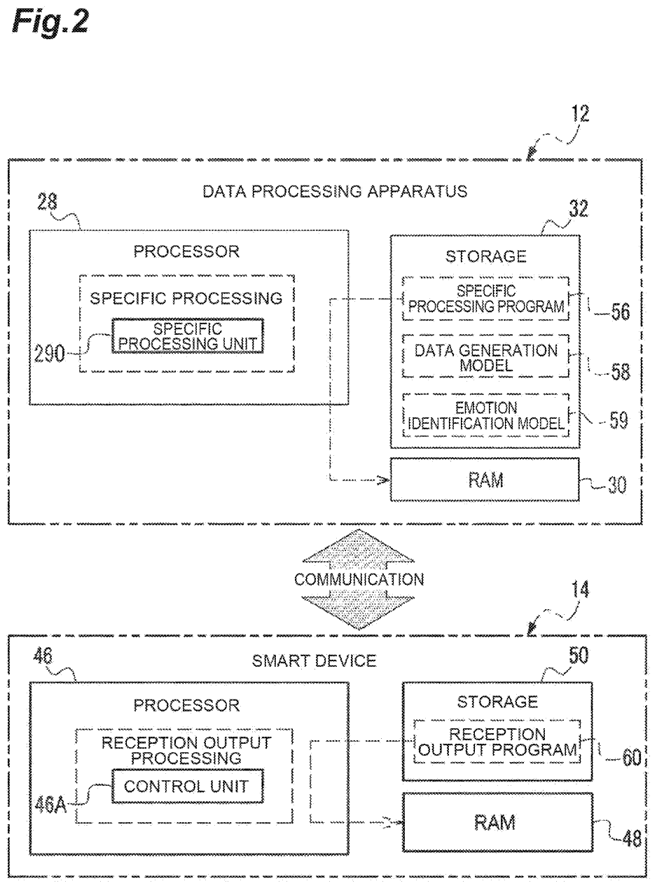

FIG. 2 illustrates an example of main functions of the data processing apparatus 12 and the smart device 14.

As illustrated in FIG. 2, in the data processing apparatus 12, specific processing is performed by the processor 28. A specific processing program 56 is stored in the storage 32. The specific processing program 56 is an example of a “program” according to the technology of the present disclosure. The processor 28 reads the specific processing program 56 from the storage 32 and executes the read specific processing program 56 on the RAM 30. The specific processing is realized by the processor 28 operating as a specific processing unit 290 in accordance with the specific processing program 56 executed on the RAM 30.

A data generation model 58 and an emotion identification model 59 are stored in the storage 32. The data generation model 58 and the emotion identification model 59 are used by the specific processing unit 290. The specific processing unit 290 can estimate a user's emotion using the emotion identification model 59 and perform specific processing using the user's emotion. In an emotion estimation function (emotion identification function) using the emotion identification model 59, various estimations and predictions regarding the user's emotion, including estimation and prediction of the user's emotion, are performed, but the present disclosure is not limited to such an example. Also, the estimation and prediction of emotion include, for example, analysis (analytics) of emotion and the like.

In the smart device 14, reception output processing is performed by the processor 46. A reception output program 60 is stored in the storage 50. The reception output program 60 is used in combination with the specific processing program 56 by the data processing system 10. The processor 46 reads the reception output program 60 from the storage 50 and executes the read reception output program 60 on the RAM 48. The specific processing is realized by the processor 46 operating as a control unit 46A in accordance with the specific processing program 60 executed on the RAM 48. Note that the smart device 14 can also have a data generation model and an emotion identification model similar to the data generation model 58 and the emotion identification model 59, and perform processing similar to that of the specific processing unit 290 using these models. The reception output processing is realized by the processor 46 operating as the control unit 46A in accordance with the reception output program 60 executed on the RAM 48.

Note that an apparatus other than the data processing apparatus 12 may have the data generation model 58. For example, a server apparatus (for example, a generation server) may have the data generation model 58. In this case, the data processing apparatus 12 obtains a processing result (such as a prediction result) in which the data generation model 58 is used, by communicating with the server apparatus having the data generation model 58. Also, the data processing apparatus 12 may be a server apparatus, or may be a terminal device owned by a user (for example, a mobile phone, a robot, a home appliance, etc.). Next, an example of processing by the data processing system 10 according to the first embodiment will be described.

### Example 1

A flow of specific processing in Example 1 will be described. Each unit of the system described below is realized by the data processing apparatus 12 and the smart device 14. Also, the data processing apparatus 12 is referred to as a “server”, and the smart device 14 is referred to as a “terminal”.

### Embodiment

As an embodiment, a more specific description will be given of how each unit is realized, with the system being configured by both a server and a terminal.

First, the MR device unit is realized by the terminal. This terminal is in the shape of a headset or smart glasses worn by the user, and includes a high-resolution display for superimposing a virtual interface on the user's field of view. The MR device unit may be configured by, for example, the smart glasses 214 or the headset-type terminal 314. This display can dynamically display information according to the user's line of sight, and when the user moves their line of sight, the displayed content also changes accordingly. Furthermore, the terminal is equipped with a plurality of cameras and depth sensors, and scans the surrounding environment in real time. This allows the terminal to accurately recognize the shape and position of objects and identify IoT home appliances. For example, when the user enters the kitchen and approaches a smart oven, the terminal recognizes the oven and visually presents operation options for temperature settings and timers.

The identification process of the IoT home appliance by the MR device unit will be described in detail. The MR device unit acquires 3D point cloud data of the environment using a mounted depth sensor (LiDAR, etc.), and performs self-localization and environment mapping using SLAM (Simultaneous Localization and Mapping) technology. The MR device unit calculates a user's gaze vector (Gaze Vector) and performs intersection determination (Ray Casting) between the vector and an object on the environment map to identify the IoT home appliance to be operated. At this time, if a plurality of home appliances are close to each other, the system uses a gaze dwell time (Dwell Time) or a keyword included in a voice instruction (e.g., “on the right”, “above”) as an auxiliary weighting coefficient to calculate a target identification score. Only when the score exceeds a predetermined threshold, the operation menu of the home appliance is superimposed and displayed. This algorithm prevents erroneous operation (False Positive) on the wrong home appliance based on physical and spatial constraints.

Next, the generative AI unit is mainly realized by the server. The generative AI unit may be configured by, for example, the specific processing unit 290, the specific processing program 56, the data generation model 58, and the emotion identification model 59. This server includes a voice recognition module for receiving the user's voice instructions, and analyzes their intent using natural language processing technology. The server has advanced computational capabilities for analyzing voice data and can process multiple voice commands simultaneously. For example, if the user gives multiple instructions such as “dim the living room lights and turn on the TV,” the server analyzes each voice and generates a command to adjust the brightness of the lights and a command to turn on the TV.

Also, the generative AI unit does not simply generate a command as text, but generates a “structured prompt (Structured Prompt)” inside the server by combining the user's voice instruction with spatial coordinate data (Spatial Coordinate Data) acquired by the MR device unit and the device ID of the home appliance. This structured prompt is input to a large language model (LLM) and converted into a specific control protocol (e.g., a command packet in JSON format) interpretable by the IoT home appliance. This conversion process eliminates the ambiguity of natural language and provides a technical effect of preventing malfunction.

Furthermore, the generative AI unit uses a machine learning algorithm to learn the user's past operation history and preferences. This learning process is performed on the server, and a model for predicting the user's behavior patterns is built. For example, if the user has a habit of starting the coffee maker at 7 a.m. every morning, the server can learn that pattern and make a suggestion to start the coffee maker before 7 a.m. It is also possible to learn the time of day when the user listens to specific music and automatically play the music at that time.

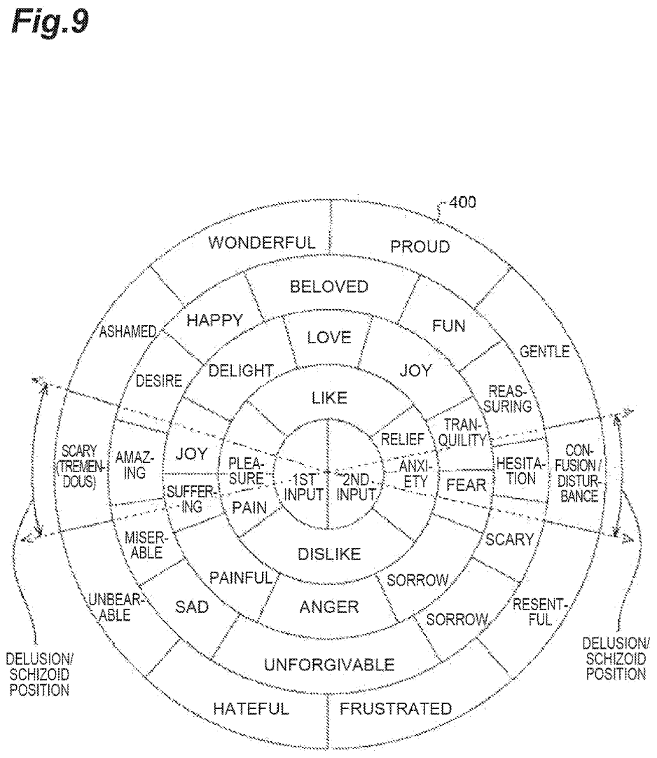

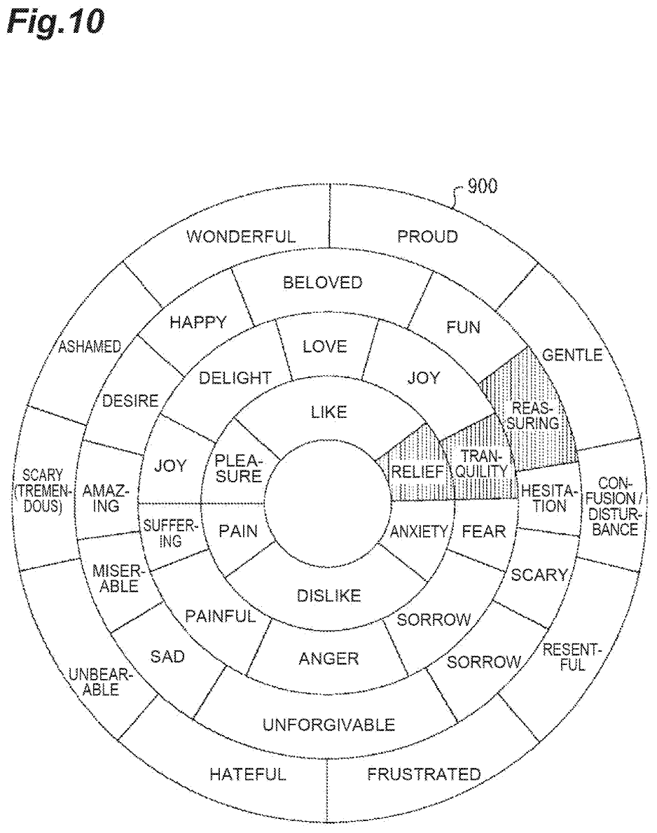

The generative AI unit dynamically adjusts the control parameters of the IoT home appliance using an emotion map (Emotion Map) shown in FIGS. 9 and 10. Specifically, the user's current emotional state is calculated as a vector value from the prosodic features (pitch, speed, intonation) of the user's voice and biological information (pulse, pupil diameter, etc.). When the calculated vector value is located in a “discomfort (Discomfort)” region (e.g., the lower region in FIG. 9) on the emotion map, the system executes an “environment adjustment mode”. In this mode, a set of physical environment parameters for promoting a transition to a predefined “comfort (Comfort)” region, such as changing the color temperature of the lighting to a warm color (e.g., 2700K) and setting the air volume of the air conditioning to “silent”, is transmitted to the IoT home appliance. By not only learning the user's preferences but also performing reinforcement learning (Reinforcement Learning) with the coordinate transition on the emotion map as an objective function, an environment that reduces unconscious stress is autonomously constructed even without explicit instructions from the user.

Furthermore, communication between the MR device unit and the generative AI unit in this system is optimized based on an edge computing architecture. The MR device unit performs lightweight preprocessing to extract feature points (Feature Points) of the IoT home appliance from the acquired image data, and transmits only the feature point data to the server, thereby realizing real-time object recognition while suppressing bandwidth consumption. This solves the problem of latency (Latency) that occurred in conventional cloud-dependent systems and enables lag-free interface display that follows the user's gaze movement.

The IoT home appliance control unit functions on both the server and the terminal. The MR device unit may be configured by, for example, the computer 36, the communication I/F 44, the specific processing unit 290, the specific processing program 56, the data generation model 58, the emotion identification model 59, and the communication I/F 26. The server has a communication means for transmitting the generated operation command to the IoT home appliance, and the terminal receives the command and controls the home appliance. Communication is performed via a wireless network, enabling real-time control. For example, a command generated by the server, such as “set the air conditioner temperature to 22 degrees,” is transmitted to the air conditioner via the terminal, and the air conditioner is adjusted to the specified temperature. In addition, the terminal transmits the state of the home appliance to the server as feedback, and the server optimizes the next operation based on that information.

In this way, by the server and the terminal operating in cooperation, the user can interact directly and naturally with the IoT home appliance. This can provide a more intuitive and efficient user experience compared to conventional indirect operation methods. Furthermore, the system aims to provide personalized services that meet the individual needs of the user and make the user's life more comfortable.

### System Configuration

The system according to the present embodiment includes an MR device unit, a generative AI unit, an IoT home appliance control unit, and a communication unit. The MR device unit is in the shape of a headset or smart glasses worn by the user, and includes a high-resolution display for superimposing a virtual interface on the user's field of view. This display can dynamically display information according to the user's line of sight, and when the user moves their line of sight, the displayed content also changes accordingly. For example, when the user enters the living room and approaches a smart light, the terminal recognizes the light and visually presents related operation options. In addition, the MR device unit is equipped with a plurality of cameras and depth sensors, and scans the surrounding environment in real time. This allows the terminal to accurately recognize the shape and position of objects and identify IoT home appliances. For example, when the user enters the kitchen and approaches a smart oven, the terminal recognizes the oven and visually presents operation options for temperature settings and timers.

The generative AI unit is mainly realized by the server, includes a voice recognition module for receiving the user's voice instructions, and analyzes their intent using natural language processing technology. The server has advanced computational capabilities for analyzing voice data and can process multiple voice commands simultaneously. For example, if the user gives multiple instructions such as “dim the living room lights and turn on the TV,” the server analyzes each voice and generates a command to adjust the brightness of the lights and a command to turn on the TV. Furthermore, the generative AI unit uses a machine learning algorithm to learn the user's past operation history and preferences. This learning process is performed on the server, and a model for predicting the user's behavior patterns is built. For example, if the user has a habit of starting the coffee maker at 7 a.m. every morning, the server can learn that pattern and make a suggestion to start the coffee maker before 7 a.m. It is also possible to learn the time of day when the user listens to specific music and automatically play the music at that time.

The IoT home appliance control unit functions on both the server and the terminal, the server has a communication means for transmitting the generated operation command to the IoT home appliance, and the terminal receives the command and controls the home appliance. Communication is performed via a wireless network, enabling real-time control. For example, a command generated by the server, such as “set the air conditioner temperature to 22 degrees,” is transmitted to the air conditioner via the terminal, and the air conditioner is adjusted to the specified temperature. In addition, the terminal transmits the state of the home appliance to the server as feedback, and the server optimizes the next operation based on that information.

The communication unit includes a wireless communication module for transmitting and receiving data between the server and the terminal, and supports communication protocols such as Wi-Fi and Bluetooth. This allows the system to ensure high communication speed and stability, and to achieve a quick response to user instructions. For example, when the user instructs “play music,” the communication unit quickly transmits the instruction to the server, and the command generated by the server is returned to the terminal, so that the music is played immediately.

Specific examples of prompt sentences to be read into the generative AI necessary for carrying out the present disclosure include “When the user enters the living room, check the status of the smart light and adjust the brightness as necessary,” “When the user starts cooking in the kitchen, set the temperature of the smart oven appropriately,” “Learn the time the user starts the coffee maker according to their morning routine and make a suggestion,” and “Based on the user's music playback history, automatically play music at a specific time of day.” With these prompt sentences, the generative AI can learn the user's behavior patterns and provide more personalized services.

### IMPLEMENTATION STEPS

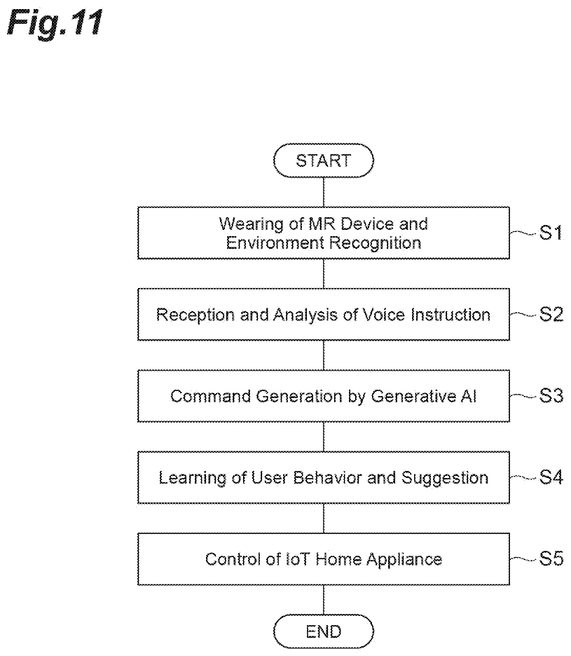

### Step 1: Wearing of MR Device and Environment Recognition (See Step S1 in FIG. 11)

The user wears the MR device and enters the surrounding environment. The MR device includes a high-resolution display for superimposing a virtual interface on the user's field of view, and the displayed content changes as the user moves their line of sight. The device is equipped with a plurality of cameras and depth sensors, scans the surrounding environment in real time, and accurately recognizes the shape and position of objects. For example, when the user enters the living room and approaches a smart light, the device recognizes the light and visually presents related operation options.

### Step 2: Reception and Analysis of Voice Instruction (See Step S2 in FIG. 11)

The user gives an instruction to the IoT home appliance by voice. For example, multiple instructions such as “dim the living room lights and turn on the TV” can be given. The generative AI unit receives these voice instructions through a voice recognition module and analyzes their intent using natural language processing technology. The server has advanced computational capabilities and can process multiple voice commands simultaneously.

### Step 3: Command Generation by Generative AI (See Step S3 in FIG. 11)

The generative AI unit generates a specific operation command based on the result of analyzing the user's voice instruction. For example, it generates a command to adjust the brightness of the lights and a command to turn on the TV. In this step, specific examples such as “When the user enters the living room, check the status of the smart light and adjust the brightness as necessary” and “When the user starts cooking in the kitchen, set the temperature of the smart oven appropriately” are used as prompt sentences to be read into the generative AI.

### Step 4: Learning of User Behavior and Suggestion (See Step S4 in FIG. 11)

The generative AI unit learns the user's past operation history and preferences using a machine learning algorithm. This learning process is performed on the server, and a model for predicting the user's behavior patterns is built. For example, if the user has a habit of starting the coffee maker at 7 a.m. every morning, the server can learn that pattern and make a suggestion to start the coffee maker before 7 a.m. A specific example of a prompt sentence in this step is “Based on the user's music playback history, automatically play music at a specific time of day.”

### Step 5: Control of IoT Home Appliance (See Step S5 in FIG. 11)

The generated operation command is transmitted to the IoT home appliance via the communication unit. Communication is performed via a wireless network, enabling real-time control. For example, a command generated by the server, such as “set the air conditioner temperature to 22 degrees,” is transmitted to the air conditioner via the terminal, and the air conditioner is adjusted to the specified temperature. In addition, the terminal transmits the state of the home appliance to the server as feedback, and the server optimizes the next operation based on that information.

### Specific Use Case

For example, suppose a user returns home and enters the living room. At this time, the user is wearing an MR device, and the device recognizes the IoT home appliances in the living room. When the user sits on the sofa and wants to relax, the MR device detects the smart light, television, and music playback device in the living room, and displays the respective operation options in the user's field of view.

The user gives an instruction by voice, “dim the lights a little, turn on the TV, and play some relaxing music.” The generative AI unit receives this voice instruction and analyzes it using natural language processing technology. Based on the analysis result, it generates a command to adjust the brightness of the lights, a command to turn on the TV, and a command to have the music playback device play relaxing music.

Specific examples of prompt sentences to be read into the generative AI include “When the user enters the living room, check the status of the smart light and adjust the brightness as necessary” and “When the user wants to relax, turn on the TV and play relaxing music.”

The generated commands are transmitted to each IoT home appliance via the communication unit. The smart light is adjusted to the specified brightness, the television turns on to the specified channel or streaming service, and the music playback device plays relaxing music from the specified playlist. This allows the user to customize the living room environment to their liking with only voice instructions.

Furthermore, the generative AI unit learns the user's past operation history and records the time of day the user enters the living room and their preferred settings at that time. For example, if the user has a habit of relaxing in the living room at the same time every night, the AI learns that pattern and can automatically make a suggestion when the user enters the living room. In this way, the user can obtain a more comfortable and personalized experience.

### Application Example 1

A flow of specific processing in Application Example 1 will be described. Each unit of the system described below is realized by the data processing apparatus 12 and the smart device 14. Also, the data processing apparatus 12 is referred to as a “server”, and the smart device 14 is referred to as a “terminal”.

### Embodiment

As an embodiment, a system utilizing MR technology and generative AI in the field of nursing care will be described in detail. This system is designed to allow a care recipient to intuitively operate various facilities and services in a nursing care facility or home environment by wearing an MR device.

First, the MR device unit is in the shape of a headset or smart glasses worn by the care recipient, and includes a high-resolution display. This display superimposes a virtual interface on the care recipient's field of view and has a plurality of cameras and depth sensors for scanning the surrounding environment in real time. For example, when the care recipient is in their own room, the MR device can recognize facilities such as the room temperature, lighting, television, and music playback device, and visually present the respective operation options. This allows the care recipient to visually check the status of the facilities and perform operations as necessary.

The generative AI unit receives the care recipient's voice instructions and analyzes their intent using natural language processing technology. The AI obtains voice data through a voice recognition module and generates a specific operation command based on the analysis result. For example, when the care recipient gives an instruction “set the room temperature to 23 degrees,” the AI generates a temperature setting command for the air conditioner, and the air conditioner is adjusted to the specified temperature. Also, when an instruction “show me the news” is given, the television automatically switches to the news channel. Furthermore, when the care recipient gives an instruction “play music,” the AI selects an appropriate playlist for the music playback device and generates a command to play the music.

Furthermore, the generative AI unit uses a machine learning algorithm to learn the care recipient's past behavior patterns and preferences. This learning process allows the AI to make appropriate suggestions in the care recipient's daily life. For example, if the care recipient has a habit of taking a walk at 2 p.m. every day, the AI displays a reminder to prepare for the walk as that time approaches. Also, if the care recipient prefers specific music, the AI automatically plays that music and provides a relaxed environment. Furthermore, the AI can learn the time and content of the care recipient's meals and make a suggestion to prompt meal preparation at the appropriate time.

The care support control unit transmits the generated operation command to the various facilities in the nursing care facility and controls the facilities based on the care recipient's instruction. Communication is performed via a wireless network, enabling real-time control. For example, a generated command “set the air conditioner temperature to 22 degrees” is transmitted to the air conditioner, and the air conditioner is adjusted to the specified temperature. In addition, the care support control unit is equipped with a function for monitoring the care recipient's state in real time and immediately transmitting an alert to a caregiver when an abnormality is detected. For example, if the care recipient falls, the sensor of the MR device detects this and transmits an alert to the caregiver's terminal. This allows the caregiver to quickly rush to the scene and take appropriate action.

In this way, the embodiment of the present disclosure aims to support the independence of the care recipient and reduce the burden on the caregiver, and it is possible to provide a more comfortable and safe care environment. The care recipient can adjust the environment according to their own needs, and the caregiver can always grasp the care recipient's state and respond quickly as needed. This can realize a better living environment for both the care recipient and the caregiver.

### System Configuration

The system according to the present embodiment includes an MR device unit, a generative AI unit, a care support control unit, and a communication unit. The MR device unit is in the shape of a headset or smart glasses worn by the care recipient, and includes a high-resolution display. This display is used to superimpose a virtual interface on the care recipient's field of view and has a plurality of cameras and depth sensors for scanning the surrounding environment in real time. For example, when the care recipient is in their own room, the MR device can recognize facilities such as the room temperature, lighting, television, and music playback device, and visually present the respective operation options. This allows the care recipient to visually check the status of the facilities and perform operations as necessary.

The generative AI unit receives the care recipient's voice instructions and analyzes their intent using natural language processing technology. The AI obtains voice data through a voice recognition module and generates a specific operation command based on the analysis result. For example, when the care recipient gives an instruction “set the room temperature to 23 degrees,” the AI generates a temperature setting command for the air conditioner, and the air conditioner is adjusted to the specified temperature. Also, when an instruction “show me the news” is given, the television automatically switches to the news channel. Furthermore, when the care recipient gives an instruction “play music,” the AI selects an appropriate playlist for the music playback device and generates a command to play the music. The generative AI unit uses a machine learning algorithm to learn the care recipient's past behavior patterns and preferences. This learning process allows the AI to make appropriate suggestions in the care recipient's daily life. For example, if the care recipient has a habit of taking a walk at 2 p.m. every day, the AI displays a reminder to prepare for the walk as that time approaches. Also, if the care recipient prefers specific music, the AI automatically plays that music and provides a relaxed environment. Furthermore, the AI can learn the time and content of the care recipient's meals and make a suggestion to prompt meal preparation at the appropriate time.

The care support control unit transmits the generated operation command to the various facilities in the nursing care facility and controls the facilities based on the care recipient's instruction. Communication is performed via a wireless network, enabling real-time control. For example, a generated command “set the air conditioner temperature to 22 degrees” is transmitted to the air conditioner, and the air conditioner is adjusted to the specified temperature. In addition, the care support control unit is equipped with a function for monitoring the care recipient's state in real time and immediately transmitting an alert to a caregiver when an abnormality is detected. For example, if the care recipient falls, the sensor of the MR device detects this and transmits an alert to the caregiver's terminal. This allows the caregiver to quickly rush to the scene and take appropriate action.

The communication unit includes a wireless communication module for transmitting and receiving data for the entire system, and supports communication protocols such as Wi-Fi and Bluetooth. This allows the system to ensure high communication speed and stability, and to achieve a quick response to user instructions. For example, when the care recipient instructs “play music,” the communication unit quickly transmits the instruction to the generative AI unit, and the command generated by the AI is returned to the care support control unit, so that the music is played immediately.

Specific examples of prompt sentences to be read into the generative AI necessary for carrying out the present disclosure include “When the care recipient wants to adjust the room temperature, optimize the air conditioner settings,” “When the care recipient wants to watch the news, switch the television to the appropriate channel,” “Learn the care recipient's walking habits and display a reminder,” and “When the care recipient falls, transmit an alert to the caregiver.” With these prompt sentences, the generative AI can learn the care recipient's behavior patterns and provide more personalized services.

### IMPLEMENTATION STEPS

### Step 1: Wearing of MR Device and Environment Recognition

The care recipient wears the MR device. This device includes a high-resolution display for superimposing a virtual interface on the care recipient's field of view. The device is equipped with a plurality of cameras and depth sensors, and scans the surrounding environment in real time. This allows the device to recognize facilities such as the room temperature, lighting, television, and music playback device, and visually present the respective operation options. The care recipient can visually check the status of the facilities and perform operations as necessary.

### Step 2: Reception and Analysis of Voice Instruction

The care recipient gives an instruction to the facilities by voice. For example, instructions such as “set the room temperature to 23 degrees,” “show me the news,” and “play music” can be given. The generative AI unit receives these voice instructions through a voice recognition module and analyzes their intent using natural language processing technology. Based on the analysis result, it generates a specific operation command.

### Step 3: Command Generation by Generative AI

The generative AI unit generates a specific operation command based on the result of analyzing the voice instruction. For example, it generates a temperature setting command for the air conditioner and a channel switching command for the television. In this step, specific examples such as “When the care recipient wants to adjust the room temperature, optimize the air conditioner settings” and “When the care recipient wants to watch the news, switch the television to the appropriate channel” are used as prompt sentences to be read into the generative AI.

### Step 4: Learning of Behavior Patterns and Suggestion

The generative AI unit learns the care recipient's past behavior patterns and preferences using a machine learning algorithm. This learning process allows the AI to make appropriate suggestions in the care recipient's daily life. For example, if the care recipient has a habit of taking a walk at 2 p.m. every day, the AI displays a reminder to prepare for the walk as that time approaches. Also, if the care recipient prefers specific music, the AI automatically plays that music and provides a relaxed environment. Specific examples of prompt sentences in this step include “Learn the care recipient's walking habits and display a reminder” and “When the care recipient falls, transmit an alert to the caregiver.”

### Step 5: Control and Monitoring of Facilities

The generated operation command is transmitted to the various facilities via the communication unit. Communication is performed via a wireless network, enabling real-time control. For example, a generated command “set the air conditioner temperature to 22 degrees” is transmitted to the air conditioner, and the air conditioner is adjusted to the specified temperature. In addition, the care support control unit is equipped with a function for monitoring the care recipient's state in real time and immediately transmitting an alert to a caregiver when an abnormality is detected. This allows the caregiver to quickly rush to the scene and take appropriate action.

### Specific Use Case

For example, consider a case where the system of the present disclosure is utilized for a care recipient to live a comfortable life at home. The care recipient is wearing an MR device and is in the living room. The MR device scans various facilities in the living room, such as the temperature, lighting, television, and music playback device, in real time, and displays operation options in the care recipient's field of view. The care recipient gives a voice instruction, “set the room temperature to 24 degrees.” The generative AI unit receives this voice instruction and analyzes it using natural language processing technology. Based on the analysis result, it generates a temperature setting command for the air conditioner and transmits it to the air conditioner via the communication unit. The air conditioner is adjusted to the specified temperature, and the care recipient can obtain a comfortable environment.

Furthermore, when the care recipient gives an instruction “show me the news,” the generative AI unit generates a command to switch the television to the news channel. The television automatically switches to the news channel, and the care recipient can watch the latest information. Also, when the care recipient gives an instruction “play some relaxing music,” the AI selects an appropriate playlist for the music playback device and generates a command to play the music. The music playback device plays the specified playlist, and the care recipient can spend a relaxing time.

The generative AI unit learns the care recipient's past behavior patterns and makes appropriate suggestions in daily life. For example, if the care recipient has a habit of drinking tea at 3 p.m. every day, the AI displays a reminder to prepare tea as that time approaches. Also, if the care recipient prefers a specific television program, the AI can make a suggestion to automatically switch the television at the broadcast time of that program.

In nursing care and home use, privacy protection is an important technical issue. In this system, the MR device unit (edge side) immediately performs masking processing or feature extraction processing on image data of a person's face or a private space (e.g., toilet, bathroom) included in the camera image. Raw image data is not transmitted to the server, and only extracted metadata (e.g., “fall detection flag: 1”, “location: living room”) is encrypted and transmitted. This distributed processing configuration achieves both high-level privacy protection and reduction of server load. In addition, even when the network is disconnected, a lightweight AI model locally cached in the MR device unit recognizes an emergency voice command (e.g., “help”) and has a fail-safe function to directly transmit an alert to a nearby caregiver terminal via Bluetooth or the like.

Specific examples of prompt sentences to be read into the generative AI necessary for carrying out the present disclosure include “When the care recipient wants to adjust the room temperature, optimize the air conditioner settings,” “When the care recipient wants to watch the news, switch the television to the appropriate channel,” “Learn the care recipient's music preferences and play relaxing music,” and “Learn the care recipient's habits and display a reminder at the appropriate time.” With these prompt sentences, the generative AI can learn the care recipient's behavior patterns and provide more personalized services.

The specific processing unit 290 transmits a result of the specific processing to the smart device 14. In the smart device 14, the control unit 46A causes the output device 40 to output the result of the specific processing. The microphone 38B acquires voice indicating a user input for the result of the specific processing. The control unit 46A transmits voice data indicating the user input acquired by the microphone 38B to the data processing apparatus 12. In the data processing apparatus 12, the specific processing unit 290 acquires the voice data.

The data generation model 58 is a so-called generative AI (Artificial Intelligence). An example of the data generation model 58 includes a generative AI such as ChatGPT (registered trademark) (Internet search <URL: https://openai.com/blog/chatgpt>). The data generation model 58 is obtained by causing a neural network to perform deep learning. A prompt including an instruction is input to the data generation model 58, and inference data such as voice data indicating voice, text data indicating text, and image data indicating an image (for example, still image data or moving image data) is input. The data generation model 58 infers the input inference data in accordance with the instruction indicated by the prompt, and outputs an inference result in one or more data formats among voice data, text data, image data, and the like. The data generation model 58 includes, for example, a text generation AI, an image generation AI, a multimodal generation AI, and the like. Here, inference refers to, for example, analysis, classification, prediction, and/or summarization, and the like. The specific processing unit 290 performs the above-described specific processing while using the data generation model 58. The data generation model 58 may be a model fine-tuned to output an inference result from a prompt that does not include an instruction, and in this case, the data generation model 58 can output an inference result from a prompt that does not include an instruction. In the data processing apparatus 12 and the like, a plurality of types of data generation models 58 are included, and the data generation model 58 includes AIs other than generative AI. AIs other than generative AI are, for example, linear regression, logistic regression, a decision tree, a random forest, a support vector machine (SVM), k-means clustering, a convolutional neural network (CNN), a recurrent neural network (RNN), a generative adversarial network (GAN), or naive Bayes, and can perform various processes, but the present disclosure is not limited to such examples. Also, the AI may be an AI agent. Also, when the processing of each unit described above is performed by an AI, the processing is partially or entirely performed by the AI, but the present disclosure is not limited to such an example. Also, a process implemented by an AI including a generative AI may be replaced with a rule-based process, and a rule-based process may be replaced with a process implemented by an AI including a generative AI.

Also, the processing by the data processing system 10 described above is executed by the specific processing unit 290 of the data processing apparatus 12 or the control unit 46A of the smart device 14, but may also be executed by the specific processing unit 290 of the data processing apparatus 12 and the control unit 46A of the smart device 14. Also, the specific processing unit 290 of the data processing apparatus 12 acquires or collects information necessary for the processing from the smart device 14 or an external device, and the smart device 14 acquires or collects information necessary for the processing from the data processing apparatus 12 or an external device.

For example, a collection unit is realized by the control unit 46A of the smart device 14 or the specific processing unit 290 of the data processing apparatus 12. For example, an acquisition unit acquires step count data using the camera 42 or the communication I/F 44 of the smart device 14, and the data is processed by the specific processing unit 290 of the data processing apparatus 12. For example, an analysis unit is realized by the specific processing unit 290 of the data processing apparatus 12, and analyzes data from the collection unit and the acquisition unit. For example, a generation unit is realized by the specific processing unit 290 of the data processing apparatus 12, and generates a cooking menu using a generative AI. For example, a provision unit is realized by the output device 40 of the smart device 14 or the specific processing unit 290 of the data processing apparatus 12, and provides the generated cooking menu to a user. The correspondence relationship between each unit and the device or the control unit is not limited to the above-described example, and various changes are possible.

In the above embodiment, an example form in which the specific processing is performed by the data processing apparatus 12 has been described, but the technology of the present disclosure is not limited to this, and the specific processing may be performed by the smart device 14.

### Second Embodiment

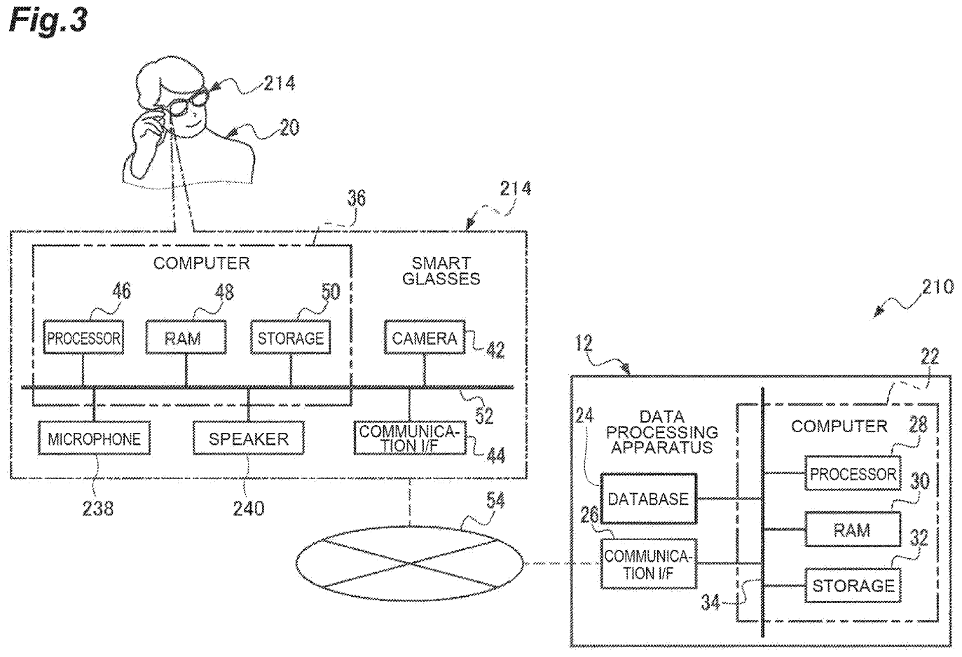

FIG. 3 illustrates an example of a configuration of a data processing system 210 according to a second embodiment.

As illustrated in FIG. 3, the data processing system 210 includes a data processing apparatus 12 and smart glasses 214. An example of the data processing apparatus 12 includes a server.

The data processing apparatus 12 includes a computer 22, a database 24, and a communication I/F 26. The computer 22 is an example of a “computer” according to the technology of the present disclosure. The computer 22 includes a processor 28, a RAM 30, and a storage 32. The processor 28, the RAM 30, and the storage 32 are connected to a bus 34. Also, the database 24 and the communication I/F 26 are also connected to the bus 34. The communication I/F 26 is connected to a network 54. An example of the network 54 includes a WAN (Wide Area Network) and/or a LAN (Local Area Network), and the like.

The smart glasses 214 include a computer 36, a microphone 238, a speaker 240, a camera 42, and a communication I/F 44. The computer 36 includes a processor 46, a RAM 48, and a storage 50. The processor 46, the RAM 48, and the storage 50 are connected to a bus 52. Also, the microphone 238, the speaker 240, and the camera 42 are also connected to the bus 52.

The microphone 238 receives an instruction or the like from a user 20 by receiving voice uttered by the user 20. The microphone 238 captures the voice uttered by the user 20, converts the captured voice into voice data, and outputs the voice data to the processor 46. The speaker 240 outputs voice in accordance with an instruction from the processor 46.

The camera 42 is a small digital camera on which an optical system such as a lens, a diaphragm, and a shutter, and an image sensor such as a CMOS (Complementary Metal-Oxide-Semiconductor) image sensor or a CCD (Charge Coupled Device) image sensor are mounted, and images the surroundings of the user 20 (for example, an imaging range defined by an angle of view corresponding to the width of the field of view of a general person with normal vision).

The communication I/F 44 is connected to the network 54. The communication I/Fs 44 and 26 manage exchange of various information between the processor 46 and the processor 28 via the network 54. The exchange of various information between the processor 46 and the processor 28 using the communication I/Fs 44 and 26 is performed in a secure state.

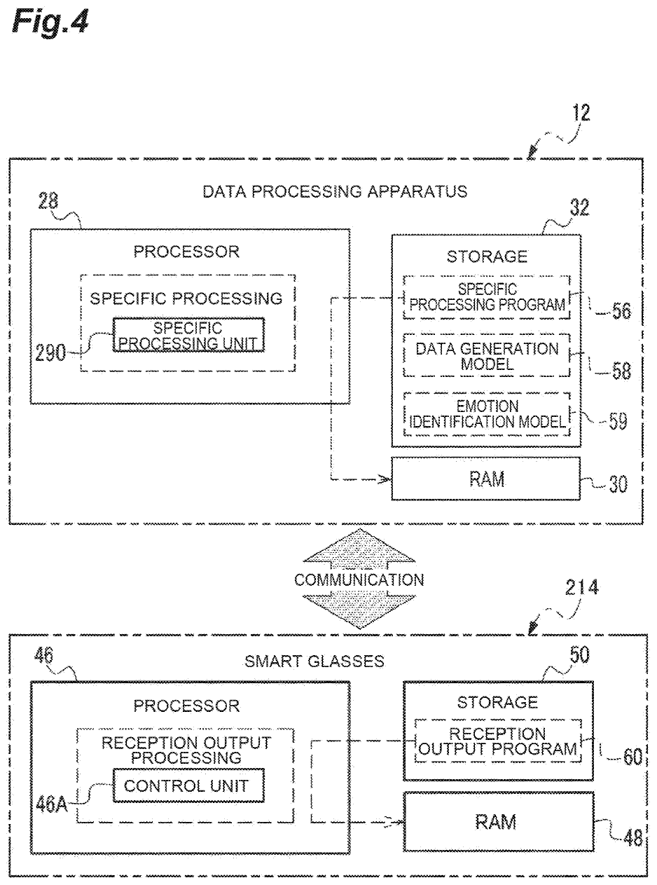

FIG. 4 illustrates an example of main functions of the data processing apparatus 12 and the smart glasses 214. As illustrated in FIG. 4, in the data processing apparatus 12, specific processing is performed by the processor 28. A specific processing program 56 is stored in the storage 32.

The specific processing program 56 is an example of a “program” according to the technology of the present disclosure. The processor 28 reads the specific processing program 56 from the storage 32 and executes the read specific processing program 56 on the RAM 30. The specific processing is realized by the processor 28 operating as a specific processing unit 290 in accordance with the specific processing program 56 executed on the RAM 30.

A data generation model 58 and an emotion identification model 59 are stored in the storage 32. The data generation model 58 and the emotion identification model 59 are used by the specific processing unit 290. The specific processing unit 290 can estimate a user's emotion using the emotion identification model 59 and perform specific processing using the user's emotion. In an emotion estimation function (emotion identification function) using the emotion identification model 59, various estimations and predictions regarding the user's emotion, including estimation and prediction of the user's emotion, are performed, but the present disclosure is not limited to such an example. Also, the estimation and prediction of emotion include, for example, analysis (analytics) of emotion and the like.

In the smart glasses 214, reception output processing is performed by the processor 46. A reception output program 60 is stored in the storage 50. The processor 46 reads the reception output program 60 from the storage 50 and executes the read reception output program 60 on the RAM 48. The reception output processing is realized by the processor 46 operating as a control unit 46A in accordance with the reception output program 60 executed on the RAM 48. Note that the smart glasses 214 can also have a data generation model and an emotion identification model similar to the data generation model 58 and the emotion identification model 59, and perform processing similar to that of the specific processing unit 290 using these models.

Next, specific processing by the specific processing unit 290 of the data processing apparatus 12 will be described. Each unit of the system described below is realized by the data processing apparatus 12 and the smart glasses 214. In the following description, the data processing apparatus 12 is referred to as a “server”, and the smart glasses 214 are referred to as a “terminal”.

### Example 1

Since the flow of the specific processing is the same as that in Example 1 described in the first embodiment, a description thereof is omitted.

### Application Example 1

Since the flow of the specific processing is the same as that in Example 1 described in the first embodiment, a description thereof is omitted.

The specific processing unit 290 transmits a result of the specific processing to the smart glasses 214. In the smart glasses 214, the control unit 46A causes the speaker 240 to output the result of the specific processing. The microphone 238 acquires voice indicating a user input for the result of the specific processing. The control unit 46A transmits voice data indicating the user input acquired by the microphone 238 to the data processing apparatus 12. In the data processing apparatus 12, the specific processing unit 290 acquires the voice data.

The data generation model 58 is a so-called generative AI (Artificial Intelligence). An example of the data generation model 58 includes a generative AI such as ChatGPT (registered trademark) (Internet search <URL: https://openai.com/blog/chatgpt>). The data generation model 58 is obtained by causing a neural network to perform deep learning. A prompt including an instruction is input to the data generation model 58, and inference data such as voice data indicating voice, text data indicating text, and image data indicating an image (for example, still image data or moving image data) is input. The data generation model 58 infers the input inference data in accordance with the instruction indicated by the prompt, and outputs an inference result in one or more data formats among voice data, text data, image data, and the like. The data generation model 58 includes, for example, a text generation AI, an image generation AI, a multimodal generation AI, and the like. Here, inference refers to, for example, analysis, classification, prediction, and/or summarization, and the like. The specific processing unit 290 performs the above-described specific processing while using the data generation model 58. The data generation model 58 may be a model fine-tuned to output an inference result from a prompt that does not include an instruction, and in this case, the data generation model 58 can output an inference result from a prompt that does not include an instruction. In the data processing apparatus 12 and the like, a plurality of types of data generation models 58 are included, and the data generation model 58 includes AIs other than generative AI. AIs other than generative AI are, for example, linear regression, logistic regression, a decision tree, a random forest, a support vector machine (SVM), k-means clustering, a convolutional neural network (CNN), a recurrent neural network (RNN), a generative adversarial network (GAN), or naive Bayes, and can perform various processes, but the present disclosure is not limited to such examples. Also, the AI may be an AI agent. Also, when the processing of each unit described above is performed by an AI, the processing is partially or entirely performed by the AI, but the present disclosure is not limited to such an example. Also, a process implemented by an AI including a generative AI may be replaced with a rule-based process, and a rule-based process may be replaced with a process implemented by an AI including a generative AI.

Also, the processing by the data processing system 10 described above is executed by the specific processing unit 290 of the data processing apparatus 12 or the control unit 46A of the smart device 14, but may also be executed by the specific processing unit 290 of the data processing apparatus 12 and the control unit 46A of the smart device 14. Also, the specific processing unit 290 of the data processing apparatus 12 acquires or collects information necessary for the processing from the smart device 14 or an external device, and the smart device 14 acquires or collects information necessary for the processing from the data processing apparatus 12 or an external device.

For example, a collection unit is realized by the control unit 46A of the smart device 14 or the specific processing unit 290 of the data processing apparatus 12. For example, an acquisition unit acquires step count data using the camera 42 or the communication I/F 44 of the smart device 14, and the data is processed by the specific processing unit 290 of the data processing apparatus 12. For example, an analysis unit is realized by the specific processing unit 290 of the data processing apparatus 12, and analyzes data from the collection unit and the acquisition unit. For example, a generation unit is realized by the specific processing unit 290 of the data processing apparatus 12, and generates a cooking menu using a generative AI. For example, a provision unit is realized by the output device 40 of the smart device 14 or the specific processing unit 290 of the data processing apparatus 12, and provides the generated cooking menu to a user. The correspondence relationship between each unit and the device or the control unit is not limited to the above-described example, and various changes are possible.

In the above embodiment, an example form in which the specific processing is performed by the data processing apparatus 12 has been described, but the technology of the present disclosure is not limited to this, and the specific processing may be performed by the smart glasses 214.

### Third Embodiment

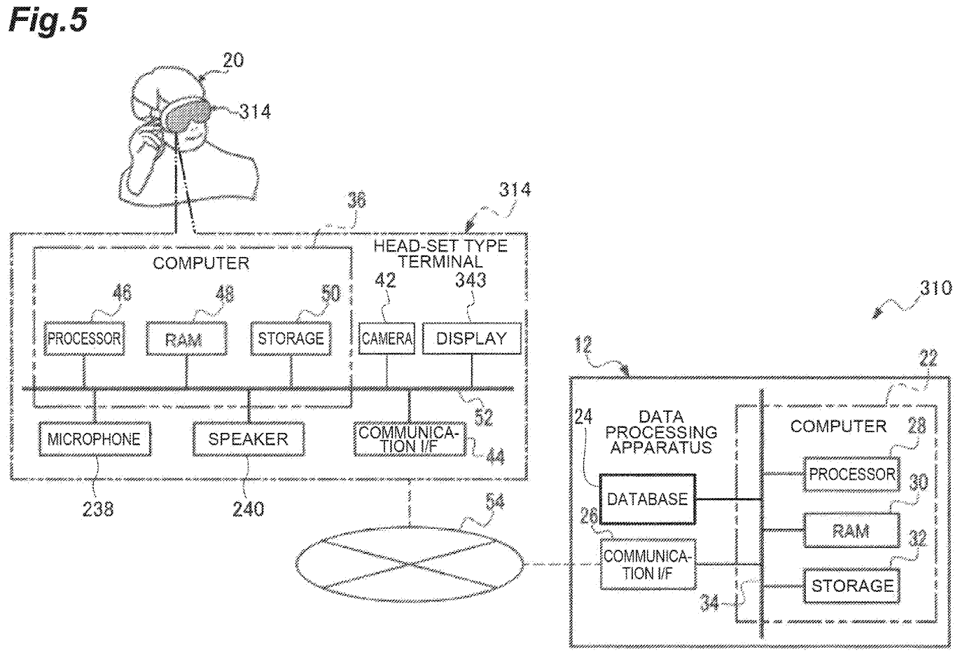

FIG. 5 illustrates an example of a configuration of a data processing system 310 according to a third embodiment.

As illustrated in FIG. 5, the data processing system 310 includes a data processing apparatus 12 and a headset-type terminal 314. An example of the data processing apparatus 12 includes a server.

The data processing apparatus 12 includes a computer 22, a database 24, and a communication I/F 26. The computer 22 is an example of a “computer” according to the technology of the present disclosure. The computer 22 includes a processor 28, a RAM 30, and a storage 32. The processor 28, the RAM 30, and the storage 32 are connected to a bus 34. Also, the database 24 and the communication I/F 26 are also connected to the bus 34. The communication I/F 26 is connected to a network 54. An example of the network 54 includes a WAN (Wide Area Network) and/or a LAN (Local Area Network), and the like.

The headset-type terminal 314 includes a computer 36, a microphone 238, a speaker 240, a camera 42, a communication I/F 44, and a display 343. The computer 36 includes a processor 46, a RAM 48, and a storage 50. The processor 46, the RAM 48, and the storage 50 are connected to a bus 52. Also, the microphone 238, the speaker 240, the camera 42, and the display 343 are also connected to the bus 52.

The microphone 238 receives an instruction or the like from a user 20 by receiving voice uttered by the user 20. The microphone 238 captures the voice uttered by the user 20, converts the captured voice into voice data, and outputs the voice data to the processor 46. The speaker 240 outputs voice in accordance with an instruction from the processor 46.

The camera 42 is a small digital camera on which an optical system such as a lens, a diaphragm, and a shutter, and an image sensor such as a CMOS (Complementary Metal-Oxide-Semiconductor) image sensor or a CCD (Charge Coupled Device) image sensor are mounted, and images the surroundings of the user 20 (for example, an imaging range defined by an angle of view corresponding to the width of the field of view of a general person with normal vision).

The communication I/F 44 is connected to the network 54. The communication I/Fs 44 and 26 manage exchange of various information between the processor 46 and the processor 28 via the network 54. The exchange of various information between the processor 46 and the processor 28 using the communication I/Fs 44 and 26 is performed in a secure state.

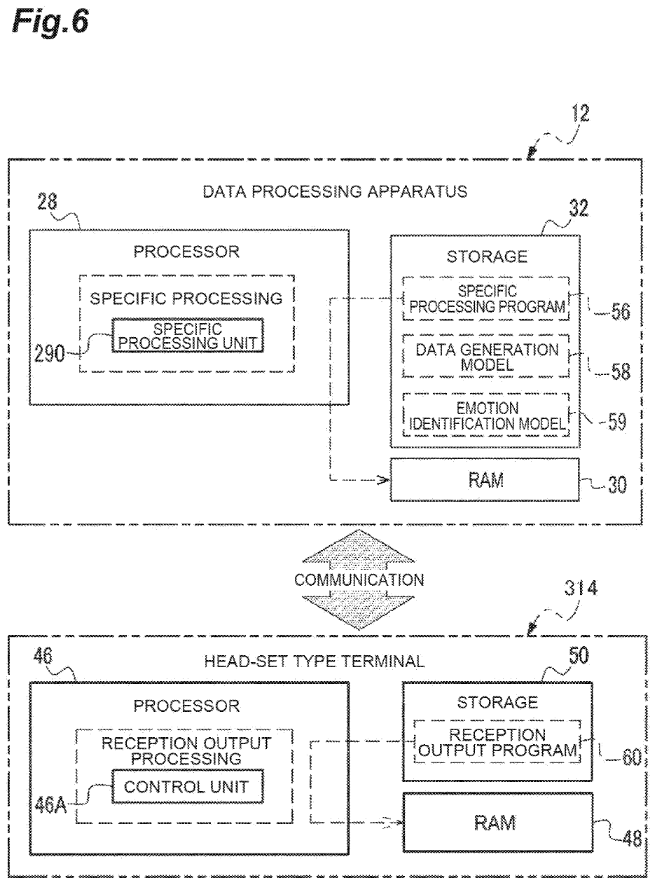

FIG. 6 illustrates an example of main functions of the data processing apparatus 12 and the headset-type terminal 314. As illustrated in FIG. 6, in the data processing apparatus 12, specific processing is performed by the processor 28. A specific processing program 56 is stored in the storage 32.

The specific processing program 56 is an example of a “program” according to the technology of the present disclosure. The processor 28 reads the specific processing program 56 from the storage 32 and executes the read specific processing program 56 on the RAM 30. The specific processing is realized by the processor 28 operating as a specific processing unit 290 in accordance with the specific processing program 56 executed on the RAM 30.

A data generation model 58 and an emotion identification model 59 are stored in the storage 32. The data generation model 58 and the emotion identification model 59 are used by the specific processing unit 290.

In the headset-type terminal 314, reception output processing is performed by the processor 46. A reception output program 60 is stored in the storage 50. The processor 46 reads the reception output program 60 from the storage 50 and executes the read reception output program 60 on the RAM 48. The reception output processing is realized by the processor 46 operating as a control unit 46A in accordance with the reception output program 60 executed on the RAM 48.

Next, specific processing by the specific processing unit 290 of the data processing apparatus 12 will be described. Each unit of the system described below is realized by the data processing apparatus 12 and the headset-type terminal 314. In the following description, the data processing apparatus 12 is referred to as a “server”, and the headset-type terminal 314 is referred to as a “terminal”.

### Example 1

Since the flow of the specific processing is the same as that in Example 1 described in the first embodiment, a description thereof is omitted.

### Application Example 1

Since the flow of the specific processing is the same as that in Example 1 described in the first embodiment, a description thereof is omitted.

The specific processing unit 290 transmits a result of the specific processing to the headset-type terminal 314. In the headset-type terminal 314, the control unit 46A causes the speaker 240 and the display 343 to output the result of the specific processing. The microphone 238 acquires voice indicating a user input for the result of the specific processing. The control unit 46A transmits voice data indicating the user input acquired by the microphone 238 to the data processing apparatus 12. In the data processing apparatus 12, the specific processing unit 290 acquires the voice data.

The data generation model 58 is a so-called generative AI (Artificial Intelligence). An example of the data generation model 58 includes a generative AI such as ChatGPT (registered trademark) (Internet search <URL: https://openai.com/blog/chatgpt>). The data generation model 58 is obtained by causing a neural network to perform deep learning. A prompt including an instruction is input to the data generation model 58, and inference data such as voice data indicating voice, text data indicating text, and image data indicating an image (for example, still image data or moving image data) is input. The data generation model 58 infers the input inference data in accordance with the instruction indicated by the prompt, and outputs an inference result in one or more data formats among voice data, text data, image data, and the like. The data generation model 58 includes, for example, a text generation AI, an image generation AI, a multimodal generation AI, and the like. Here, inference refers to, for example, analysis, classification, prediction, and/or summarization, and the like. The specific processing unit 290 performs the above-described specific processing while using the data generation model 58. The data generation model 58 may be a model fine-tuned to output an inference result from a prompt that does not include an instruction, and in this case, the data generation model 58 can output an inference result from a prompt that does not include an instruction. In the data processing apparatus 12 and the like, a plurality of types of data generation models 58 are included, and the data generation model 58 includes AIs other than generative AI. AIs other than generative AI are, for example, linear regression, logistic regression, a decision tree, a random forest, a support vector machine (SVM), k-means clustering, a convolutional neural network (CNN), a recurrent neural network (RNN), a generative adversarial network (GAN), or naive Bayes, and can perform various processes, but the present disclosure is not limited to such examples. Also, the AI may be an AI agent. Also, when the processing of each unit described above is performed by an AI, the processing is partially or entirely performed by the AI, but the present disclosure is not limited to such an example. Also, a process implemented by an AI including a generative AI may be replaced with a rule-based process, and a rule-based process may be replaced with a process implemented by an AI including a generative AI.

Also, the processing by the data processing system 10 described above is executed by the specific processing unit 290 of the data processing apparatus 12 or the control unit 46A of the smart device 14, but may also be executed by the specific processing unit 290 of the data processing apparatus 12 and the control unit 46A of the smart device 14. Also, the specific processing unit 290 of the data processing apparatus 12 acquires or collects information necessary for the processing from the smart device 14 or an external device, and the smart device 14 acquires or collects information necessary for the processing from the data processing apparatus 12 or an external device.

For example, a collection unit is realized by the control unit 46A of the smart device 14 or the specific processing unit 290 of the data processing apparatus 12. For example, an acquisition unit acquires step count data using the camera 42 or the communication I/F 44 of the smart device 14, and the data is processed by the specific processing unit 290 of the data processing apparatus 12. For example, an analysis unit is realized by the specific processing unit 290 of the data processing apparatus 12, and analyzes data from the collection unit and the acquisition unit. For example, a generation unit is realized by the specific processing unit 290 of the data processing apparatus 12, and generates a cooking menu using a generative AI. For example, a provision unit is realized by the output device 40 of the smart device 14 or the specific processing unit 290 of the data processing apparatus 12, and provides the generated cooking menu to a user. The correspondence relationship between each unit and the device or the control unit is not limited to the above-described example, and various changes are possible.

In the above embodiment, an example form in which the specific processing is performed by the data processing apparatus 12 has been described, but the technology of the present disclosure is not limited to this, and the specific processing may be performed by the headset-type terminal 314.

### Fourth Embodiment

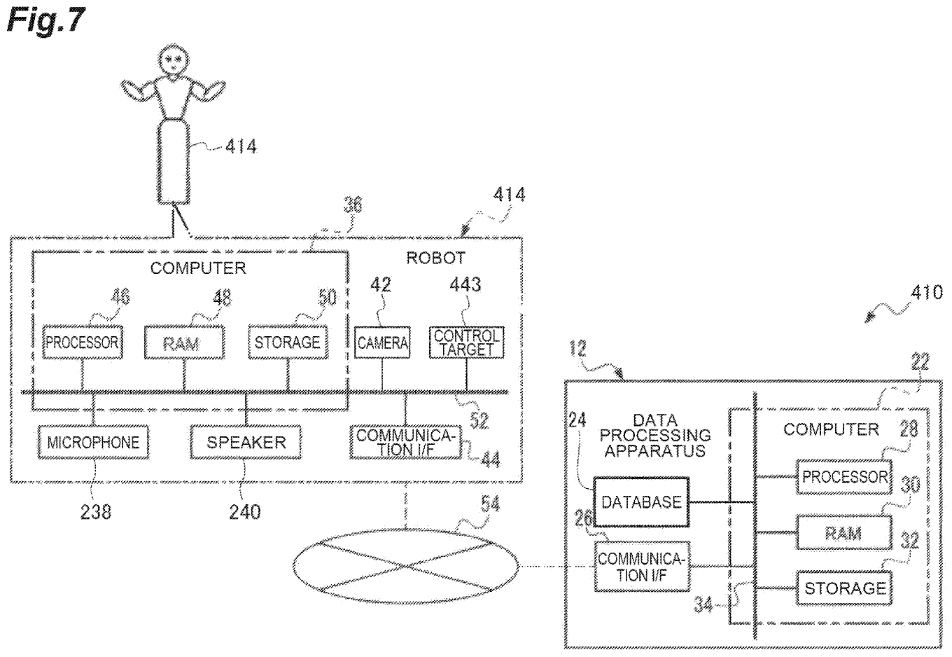

FIG. 7 illustrates an example of a configuration of a data processing system 410 according to a fourth embodiment.

As illustrated in FIG. 7, the data processing system 410 includes a data processing apparatus 12 and a robot 414. An example of the data processing apparatus 12 includes a server.

The data processing apparatus 12 includes a computer 22, a database 24, and a communication I/F 26. The computer 22 is an example of a “computer” according to the technology of the present disclosure. The computer 22 includes a processor 28, a RAM 30, and a storage 32. The processor 28, the RAM 30, and the storage 32 are connected to a bus 34. Also, the database 24 and the communication I/F 26 are also connected to the bus 34. The communication I/F 26 is connected to a network 54. An example of the network 54 includes a WAN (Wide Area Network) and/or a LAN (Local Area Network), and the like.

The robot 414 includes a computer 36, a microphone 238, a speaker 240, a camera 42, a communication I/F 44, and a control target 443. The computer 36 includes a processor 46, a RAM 48, and a storage 50. The processor 46, the RAM 48, and the storage 50 are connected to a bus 52. Also, the microphone 238, the speaker 240, the camera 42, and the control target 443 are also connected to the bus 52.

The microphone 238 receives an instruction or the like from a user 20 by receiving voice uttered by the user 20. The microphone 238 captures the voice uttered by the user 20, converts the captured voice into voice data, and outputs the voice data to the processor 46. The speaker 240 outputs voice in accordance with an instruction from the processor 46.

The camera 42 is a small digital camera on which an optical system such as a lens, a diaphragm, and a shutter, and an image sensor such as a CMOS (Complementary Metal-Oxide-Semiconductor) image sensor or a CCD (Charge Coupled Device) image sensor are mounted, and images the surroundings of the user 20 (for example, an imaging range defined by an angle of view corresponding to the width of the field of view of a general person with normal vision).

The communication I/F 44 is connected to the network 54. The communication I/Fs 44 and 26 manage exchange of various information between the processor 46 and the processor 28 via the network 54. The exchange of various information between the processor 46 and the processor 28 using the communication I/Fs 44 and 26 is performed in a secure state.

The control target 443 includes a display device, an LED of an eye part, and motors that drive an arm, a hand, a leg, and the like. The posture and gestures of the robot 414 are controlled by controlling the motors of the arm, hand, leg, and the like. A part of the emotions of the robot 414 can be expressed by controlling these motors. Also, the facial expression of the robot 414 can also be expressed by controlling the light emission state of the LED of the eye part of the robot 414.

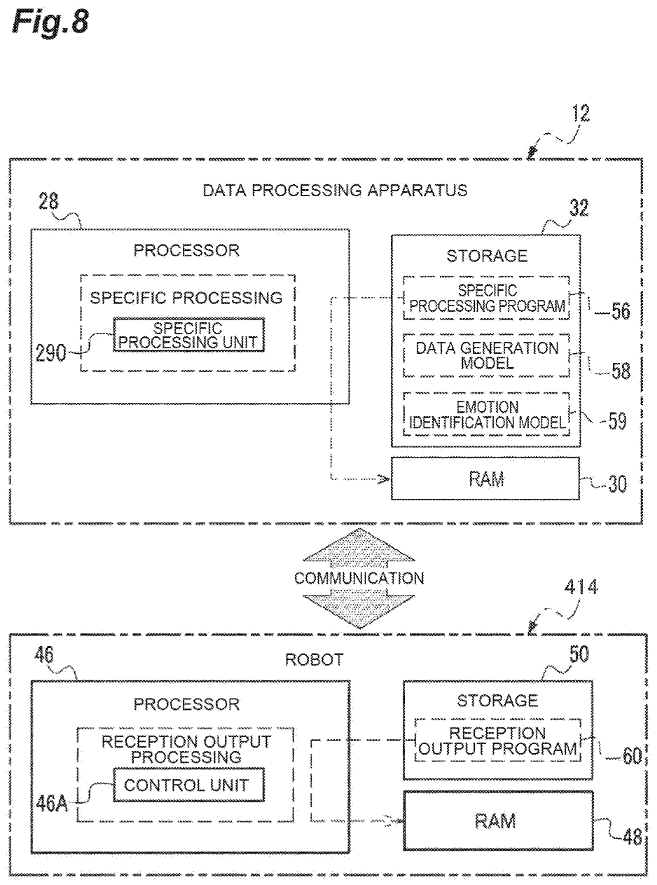

FIG. 8 illustrates an example of main functions of the data processing apparatus 12 and the robot 414. As illustrated in FIG. 8, in the data processing apparatus 12, specific processing is performed by the processor 28. A specific processing program 56 is stored in the storage 32.

The specific processing program 56 is an example of a “program” according to the technology of the present disclosure. The processor 28 reads the specific processing program 56 from the storage 32 and executes the read specific processing program 56 on the RAM 30. The specific processing is realized by the processor 28 operating as a specific processing unit 290 in accordance with the specific processing program 56 executed on the RAM 30.

A data generation model 58 and an emotion identification model 59 are stored in the storage 32. The data generation model 58 and the emotion identification model 59 are used by the specific processing unit 290.

In the robot 414, reception output processing is performed by the processor 46. A reception output program 60 is stored in the storage 50. The processor 46 reads the reception output program 60 from the storage 50 and executes the read reception output program 60 on the RAM 48. The reception output processing is realized by the processor 46 operating as a control unit 46A in accordance with the reception output program 60 executed on the RAM 48.

Next, specific processing by the specific processing unit 290 of the data processing apparatus 12 will be described. Each unit of the system described below is realized by the data processing apparatus 12 and the robot 414. In the following description, the data processing apparatus 12 is referred to as a “server”, and the robot 414 is referred to as a “terminal”.

### Example 1

Since the flow of the specific processing is the same as that in Example 1 described in the first embodiment, a description thereof is omitted.

### Application Example 1

Since the flow of the specific processing is the same as that in Example 1 described in the first embodiment, a description thereof is omitted.

The specific processing unit 290 transmits a result of the specific processing to the robot 414. In the robot 414, the control unit 46A causes the speaker 240 and the control target 443 to output the result of the specific processing. The microphone 238 acquires voice indicating a user input for the result of the specific processing. The control unit 46A transmits voice data indicating the user input acquired by the microphone 238 to the data processing apparatus 12. In the data processing apparatus 12, the specific processing unit 290 acquires the voice data.

The data generation model 58 is a so-called generative AI (Artificial Intelligence). An example of the data generation model 58 includes a generative AI such as ChatGPT (registered trademark) (Internet search <URL: https://openai.com/blog/chatgpt>). The data generation model 58 is obtained by causing a neural network to perform deep learning. A prompt including an instruction is input to the data generation model 58, and inference data such as voice data indicating voice, text data indicating text, and image data indicating an image (for example, still image data or moving image data) is input. The data generation model 58 infers the input inference data in accordance with the instruction indicated by the prompt, and outputs an inference result in one or more data formats among voice data, text data, image data, and the like. The data generation model 58 includes, for example, a text generation AI, an image generation AI, a multimodal generation AI, and the like. Here, inference refers to, for example, analysis, classification, prediction, and/or summarization, and the like. The specific processing unit 290 performs the above-described specific processing while using the data generation model 58. The data generation model 58 may be a model fine-tuned to output an inference result from a prompt that does not include an instruction, and in this case, the data generation model 58 can output an inference result from a prompt that does not include an instruction. In the data processing apparatus 12 and the like, a plurality of types of data generation models 58 are included, and the data generation model 58 includes AIs other than generative AI. AIs other than generative AI are, for example, linear regression, logistic regression, a decision tree, a random forest, a support vector machine (SVM), k-means clustering, a convolutional neural network (CNN), a recurrent neural network (RNN), a generative adversarial network (GAN), or naive Bayes, and can perform various processes, but the present disclosure is not limited to such examples. Also, the AI may be an AI agent. Also, when the processing of each unit described above is performed by an AI, the processing is partially or entirely performed by the AI, but the present disclosure is not limited to such an example. Also, a process implemented by an AI including a generative AI may be replaced with a rule-based process, and a rule-based process may be replaced with a process implemented by an AI including a generative AI.

Also, the processing by the data processing system 10 described above is executed by the specific processing unit 290 of the data processing apparatus 12 or the control unit 46A of the smart device 14, but may also be executed by the specific processing unit 290 of the data processing apparatus 12 and the control unit 46A of the smart device 14. Also, the specific processing unit 290 of the data processing apparatus 12 acquires or collects information necessary for the processing from the smart device 14 or an external device, and the smart device 14 acquires or collects information necessary for the processing from the data processing apparatus 12 or an external device.

For example, a collection unit is realized by the control unit 46A of the smart device 14 or the specific processing unit 290 of the data processing apparatus 12. For example, an acquisition unit acquires step count data using the camera 42 or the communication I/F 44 of the smart device 14, and the data is processed by the specific processing unit 290 of the data processing apparatus 12. For example, an analysis unit is realized by the specific processing unit 290 of the data processing apparatus 12, and analyzes data from the collection unit and the acquisition unit. For example, a generation unit is realized by the specific processing unit 290 of the data processing apparatus 12, and generates a cooking menu using a generative AI. For example, a provision unit is realized by the output device 40 of the smart device 14 or the specific processing unit 290 of the data processing apparatus 12, and provides the generated cooking menu to a user. The correspondence relationship between each unit and the device or the control unit is not limited to the above-described example, and various changes are possible.

In the above embodiment, an example form in which the specific processing is performed by the data processing apparatus 12 has been described, but the technology of the present disclosure is not limited to this, and the specific processing may be performed by the robot 414.

Note that the emotion identification model 59 as an emotion engine may determine a user's emotion according to a specific mapping. Specifically, the emotion identification model 59 may determine the user's emotion according to an emotion map (see FIG. 9), which is a specific mapping. Also, the emotion identification model 59 may similarly determine the robot's emotion, and the specific processing unit 290 may perform specific processing using the robot's emotion.

FIG. 9 is a diagram illustrating an emotion map 400 on which a plurality of emotions are mapped. In the emotion map 400, emotions are arranged in concentric circles radiating from the center. The closer to the center of the concentric circles, the more primitive the state of the emotion is arranged. On the outer side of the concentric circles, emotions representing states and actions arising from a state of mind are arranged. Emotion is a concept that also includes affect and mental states. On the left side of the concentric circles, emotions generated from reactions that generally occur in the brain are arranged. On the right side of the concentric circles, emotions that are generally induced by situational judgment are arranged. In the upward and downward directions of the concentric circles, emotions that are generated from reactions that generally occur in the brain and are induced by situational judgment are arranged. Also, on the upper side of the concentric circles, “pleasant” emotions are arranged, and on the lower side, “unpleasant” emotions are arranged. In this way, in the emotion map 400, a plurality of emotions are mapped based on the structure in which emotions are generated, and emotions that are likely to occur at the same time are mapped close to each other.

These emotions are distributed in the 3 o'clock direction of the emotion map 400, and usually go back and forth between relief and anxiety. In the right half of the emotion map 400, situational awareness is superior to internal sensations, resulting in a calm impression.

Since the inside of the emotion map 400 represents the inside of the mind and the outside of the emotion map 400 represents actions, the further one goes to the outside of the emotion map 400, the more visible (manifested in action) the emotion becomes.

Here, human emotions are based on various balances such as posture and blood sugar levels, and show a state of unpleasantness when those balances move away from the ideal, and a state of pleasantness when they approach the ideal. In robots, automobiles, motorcycles, and the like as well, emotions can be created based on various balances such as posture and remaining battery level, so as to show a state of unpleasantness when those balances move away from the ideal, and a state of pleasantness when they approach the ideal. The emotion map may be generated based on, for example, Dr. Mitsuyoshi's emotion map (Research on a speech emotion recognition and brain physiological signal analysis system of affect, Tokushima University, doctoral dissertation: https://ci.nii.ac.jp/naid/500000375379). In the left half of the emotion map, emotions belonging to a region called “reaction” where sensation is dominant are arranged. Also, in the right half of the emotion map, emotions belonging to a region called “situation” where situational awareness is dominant are arranged.

In the emotion map, two emotions that promote learning are defined. One is an emotion around the middle of negative “remorse” and “reflection” on the situation side. That is, it is when a negative emotion such as “I never want to feel this way again” or “I don't want to be scolded anymore” arises in the robot. The other is an emotion around positive “desire” on the reaction side. That is, it is when there is a positive feeling such as “I want more” or “I want to know more”.

The emotion identification model 59 inputs a user input into a pre-trained neural network, acquires an emotion value indicating each emotion shown in the emotion map 400, and determines the user's emotion. This neural network is pre-trained based on a plurality of learning data that are combinations of user inputs and emotion values indicating each emotion shown in the emotion map 400. Also, this neural network is trained such that emotions arranged close to each other have close values, as in the emotion map 900 shown in FIG. 10. FIG. 10 shows an example in which a plurality of emotions, “relief,” “peace of mind,” and “reassured,” have close emotion values.

Although the system according to the present disclosure has been described above mainly with respect to the functions of the data processing apparatus 12, the system according to the present disclosure is not necessarily implemented in a server. The system according to the present disclosure may be implemented as a general information processing system. The present disclosure may be implemented as, for example, a software program that runs on a personal computer, or an application that runs on a smartphone or the like. The method according to the present disclosure may be provided to a user in a SaaS (Software as a Service) format.

In the above embodiment, an example form in which the specific processing is performed by one computer 22 has been described, but the technology of the present disclosure is not limited to this, and distributed processing for the specific processing may be performed by a plurality of computers including the computer 22. For example, the data generation model 58 may be provided in an external device of the data processing apparatus 12, and the external device may generate data according to the input data.

In the above embodiment, an example form in which the specific processing program 56 is stored in the storage 32 has been described, but the technology of the present disclosure is not limited to this. For example, the specific processing program 56 may be stored in a portable computer-readable non-transitory storage medium such as a USB (Universal Serial Bus) memory. The specific processing program 56 stored in the non-transitory storage medium is installed in the computer 22 of the data processing apparatus 12. The processor 28 executes the specific processing according to the specific processing program 56.

Also, the specific processing program 56 may be stored in a storage device such as a server connected to the data processing apparatus 12 via the network 54, and the specific processing program 56 may be downloaded in response to a request from the data processing apparatus 12 and installed in the computer 22.

Note that it is not necessary to store all of the specific processing program 56 in a storage device such as a server connected to the data processing apparatus 12 via the network 54, or to store all of the specific processing program 56 in the storage 32, and a part of the specific processing program 56 may be stored.

As hardware resources for executing the specific processing, various processors shown below can be used. Examples of the processor include a CPU, which is a general-purpose processor that functions as a hardware resource for executing the specific processing by executing software, that is, a program. Also, examples of the processor include a dedicated electric circuit, which is a processor having a circuit configuration specifically designed to execute specific processing, such as an FPGA (Field-Programmable Gate Array), a PLD (Programmable Logic Device), or an ASIC (Application Specific Integrated Circuit). A memory is built in or connected to any of the processors, and any of the processors executes the specific processing by using the memory.

The hardware resource that executes the specific processing may be configured by one of these various processors, or may be configured by a combination of two or more processors of the same type or different types (for example, a combination of a plurality of FPGAs, or a combination of a CPU and an FPGA). Also, the hardware resource that executes the specific processing may be one processor.

As an example of a configuration with one processor, first, there is a form in which one processor is configured by a combination of one or more CPUs and software, and this processor functions as a hardware resource for executing the specific processing. Second, there is a form in which a processor that realizes the functions of an entire system including a plurality of hardware resources for executing the specific processing with one IC chip, as represented by an SoC (System-on-a-chip) or the like, is used. In this way, the specific processing is realized using one or more of the various processors described above as hardware resources.

Furthermore, as a hardware structure of these various processors, more specifically, an electric circuit in which circuit elements such as semiconductor elements are combined can be used. Also, the specific processing described above is merely an example. Therefore, it goes without saying that unnecessary steps may be deleted, new steps may be added, or the processing order may be changed within a scope that does not depart from the gist.

The description and illustrations shown above are detailed descriptions of the parts related to the technology of the present disclosure, and are merely an example of the technology of the present disclosure. For example, the description regarding the above-described configuration, function, operation, and effect is a description regarding an example of the configuration, function, operation, and effect of the part related to the technology of the present disclosure. Therefore, it goes without saying that unnecessary parts may be deleted, new elements may be added, or replacements may be made to the description and illustrations shown above within a scope that does not depart from the gist of the technology of the present disclosure. Also, in order to avoid confusion and facilitate understanding of the parts related to the technology of the present disclosure, in the description and illustrations shown above, descriptions regarding common general technical knowledge and the like that do not require particular explanation for enabling the implementation of the technology of the present disclosure are omitted.

All documents, patent applications, and technical standards described in this specification are incorporated herein by reference to the same extent as if each individual document, patent application, and technical standard were specifically and individually indicated to be incorporated by reference.

Regarding the above embodiments, the following is further disclosed.

### Application Example 1

A system comprising an MR device unit, a generative AI unit, and a care support control unit. The MR device unit is in the shape of a headset or smart glasses worn by a care recipient, includes a high-resolution display for superimposing a virtual interface on the care recipient's field of view, and has a plurality of cameras and depth sensors for scanning the surrounding environment in real time and recognizing various facilities in a nursing care facility. The generative AI unit includes a voice recognition module and a machine learning algorithm for receiving a voice instruction from the care recipient, analyzing its intent using natural language processing technology, and generating a specific operation command, and builds a model for learning the care recipient's past behavior patterns and making appropriate suggestions in daily life. The care support control unit has a communication means for transmitting the generated operation command to the various facilities in the nursing care facility and controlling the facilities based on the care recipient's instruction, and includes a function for monitoring the care recipient's state in real time and immediately transmitting an alert to a caregiver when an abnormality is detected.

The system, wherein when the care recipient wears the MR device unit and gives a voice instruction to the various facilities in the nursing care facility, the generative AI unit analyzes the voice instruction and generates a specific operation command. Accordingly, the care recipient can adjust the environment according to their own needs, for example, setting the room temperature to a specified temperature or switching the television to a specific channel.

The system, wherein the generative AI unit learns the care recipient's past behavior patterns and makes appropriate suggestions in daily life. Accordingly, if the care recipient has a habit of taking medicine at a fixed time every day, the AI reminds the care recipient to take the medicine as that time approaches, and if the care recipient prefers specific music, the AI can automatically play that music. Furthermore, if the care recipient falls, a sensor detects this and transmits an alert to the caregiver, enabling a prompt response.

An IoT home appliance control system comprising: a display; a sensor; and a circuit, wherein the display is configured to superimpose a virtual interface on a user's field of view, wherein the sensor is configured to scan a surrounding environment to recognize an IoT home appliance, and wherein the circuit is configured to: analyze a voice instruction from the user to generate an operation command corresponding to the voice instruction from the user; and generate a control signal for controlling the IoT home appliance based on the operation command.

The system, wherein the circuit is configured to: learn a past operation history of the user.

The system, wherein when the user wearing an MR device including the display and the sensor approaches the IoT home appliance: the sensor identifies the IoT home appliance; and the display displays operation options corresponding to the IoT home appliance in the field of view of the user.

The system, wherein the circuit is configured to: learn the past operation history and preferences of the user; predict a behavior pattern of the user based on a result of the learning; and generate the operation command based on a result of the prediction.

An IoT home appliance control method using an IoT home appliance control system, wherein the IoT home appliance control system includes a display and a sensor, the method comprising: superimposing, by the display, a virtual interface on a user's field of view; scanning, by the sensor, a surrounding environment to recognize an IoT home appliance; analyzing a voice instruction from the user to generate an operation command corresponding to the voice instruction from the user; and generating a control signal for controlling the IoT home appliance based on the operation command.

1. An IoT home appliance control system comprising:
a display;
a sensor; and a circuit,
wherein the display is configured to superimpose a virtual interface on a user's field of view,
wherein the sensor is configured to scan a surrounding environment to recognize an IoT home appliance, and
wherein the circuit is configured to:
analyze a voice instruction from the user to generate an operation command corresponding to the voice instruction from the user; and
generate a control signal for controlling the IoT home appliance based on the operation command.

2. The system according to claim 1,
wherein the circuit is configured to:
learn a past operation history of the user.

3. The system according to claim 1,
wherein when the user wearing an MR device including the display and the sensor approaches the IoT home appliance:
the sensor identifies the IoT home appliance; and
the display displays operation options corresponding to the IoT home appliance in the field of view of the user.

4. The system according to claim 1,
wherein the circuit is configured to:
learn a past operation history and preferences of the user;
predict a behavior pattern of the user based on a result of the learning; and
generate the operation command based on a result of the prediction.

5. An IoT home appliance control method using an IoT home appliance control system, wherein the IoT home appliance control system includes a display and a sensor,
the method comprising:
superimposing, by the display, a virtual interface on a user's field of view;
scanning, by the sensor, a surrounding environment to recognize an IoT home appliance;
analyzing a voice instruction from the user to generate an operation command corresponding to the voice instruction from the user; and
generating a control signal for controlling the IoT home appliance based on the operation command.
